(19) United States
(12) Patent Application Publication
(10) Pub. No.: US 2006/0164685 A1
(43) Pub. Date: Jul. 27, 2006

(54) Printing system, method and program, display, and printer

(75) Inventor: Masaya Kobayashi, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/660,735

(22) Filed: Sep. 12, 2003

(30) Foreign Application Priority Data
Sep. 13, 2002 (JP) P2002-268083

(51) Int. Cl. G06K 15/00

(52) U.S. Cl. 358/1.18

(57) ABSTRACT

A print system includes an input unit for inputting content; an operation unit for the user to set a print condition and enter a print execution command; a print unit for printing the input content on a medium based on the setup print condition when the user enters a print execution command; and a display unit for displaying content laid out for the page being printed in the print unit. The user monitors the content laid out for the page being printed on the display unit.

### BACKGROUND OF THE INVENTION

This invention relates to a print system, method, and program, a display, and a printer.

Hitherto, a print system in a related art for printing input data on a medium such as paper has been known. When the print system in the related art accepts a print execution command entered by the user and starts printing, the user cannot watch what content is laid out for the current page being printed without seeing the print result. For example, to continuously print a plurality of pages each for which image data as content is laid out, the print system in the related art requires that the user should see the in-progress print result of the current page being printed to know which image data is laid out for the page being printed at present.

However, if some event occurs after a print execution command is given and printing the page for which predetermined content is laid out is to be canceled, the print system in the related art requires that the user should provide the timing to give a print cancel command while fully checking the print result of the page being printed. Whether or not the current page being printed is the page to cancel the printing cannot be determined unless printing the page proceeds to some extent. Therefore, to determine the timing to give a print cancel command while fully checking the print result of the page being printed, inevitably the timing to give a print cancel command is delayed. Consequently, paper, ink, the print time, and the like are wasted.

According to the print system in the related art, the user cannot watch what content is laid out for the current page being printed without seeing the print result. Thus, the print system in the related art cannot give the user a feeling of being safe that the printing proceeds normally.

### SUMMARY OF THE INVENTION

It is therefore an object of the invention to provide a print system, method, and program for enabling the user to monitor the content laid out for the page being printed without seeing the print result.

It is another object of the invention to provide a display for enabling the user to monitor the content being printed without seeing the print result.

It is still another object of the invention to provide an easy-to-handle printer for enabling the user to monitor the content being printed without seeing the print result and cancel print.

According to the invention as claimed in claim 1, there is provided a print system including an input unit for inputting content; an operation unit for the user to set a print condition and enter a print execution command; a print unit for printing the input content on a medium based on the setup print condition when the user enters a print execution command; and a display unit for displaying content laid out for the page being printed in the print unit.

According to the print system according to claim 1, the content laid out for the page being printed is displayed, so that the user can monitor the content laid out for the page being printed without seeing the print result. The term “content” refers to data that can be laid for one area specified in one page; specifically, for example, it refers to image data, text data, etc. The displayed content and the printed content are allowed if the entities represented by them are the same, and are not limited to the same data printed and displayed. Specifically, for example, the printed content may be high-resolution image data and the displayed content may be low-resolution image data. Displaying of content contains not only displaying of the whole of the content, but also displaying of a part of the content or displaying of an identification label of the content such as a file name.

The display unit of the print system according to claim 2 displays the whole of the page being printed in the print unit.

According to the print system according to claim 2, the whole of the page being printed is displayed, so that the user can easily determine the page being printed.

The display unit of the print system according to claim 3 displays the content laid out for the page to be printed in the print unit before print is started.

According to the print system according to claim 3, content is displayed before print is started. Thus, before printing a specific page is started, the user can perform operation required for canceling printing the page.

The print system according to claim 4 further includes nonvolatile memory storing print layout definition information for laying out content for paper and display layout definition information for laying out content for a screen.

According to the print system according to claim 4, the display layout definition information is stored in the nonvolatile memory separately from the print layout definition information, so that the processing of laying out content for a predetermined position of the screen and displaying can be executed in a short time.

The print system according to claim 5 further includes a housing where the input unit, the operation unit, the print unit, and the display unit are provided, wherein the input unit inputs data stored in removable memory.

According to the print system according to claim 5, the whole system is placed in one piece in the housing, so that the system is easily handled.

According to the invention as claimed in claim 6, there is provided a print method including the steps of inputting content; and printing the input content on a medium and displaying content laid out for the page being printed.

According to the print method according to claim 6, the content laid out for the page being printed is displayed, so that the user can monitor the content laid out for the page being printed without seeing the print result.

According to the invention as claimed in claim 7, there is provided a program for causing a computer for controlling a print system including an input unit for inputting content, an operation unit for the user to set a print condition and enter a print execution command, a print unit for printing the input content on a medium based on the setup print condition when the user enters a print execution command, and a display unit to function as a unit for causing the display unit to display content laid out for the page being printed in the print unit.

According to the program according to claim 7, the content laid out for the page being printed is displayed, so that the user can monitor the content laid out for the page being printed without seeing the print result.

According to the invention as claimed in claim 8, there is provided a display for displaying print content, including a display unit for displaying content with print specified on a screen; and a control unit for causing the display unit to display the content being printed if a plurality of contents are printed continuously over a plurality of pages.

According to the display according to claim 8, the user can monitor the content being printed without seeing the print result.

The control unit of the display according to claim 9 causes the display unit to display the content to be printed before printing the content is started.

According to the display according to claim 9, content is displayed before print is started. Thus, before printing a specific page is started, the user can perform operation required for canceling printing the page.

The control unit of the display according to claim 10 stops display switching of the content to be printed based on a print cancel command.

According to the display according to claim 10, when print is canceled, display switching is stopped. Thus, switching of only display although print is canceled is avoided. Therefore, the user who monitors the content being printed does not get confused.

The control unit of the display according to claim 11 causes the display unit to display at least a part of each content.

According to the display according to claim 11, if the user can monitor each content based on at least a part of the content, at least a part of the content is displayed, enabling the user to monitor the content being printed.

According to the invention as claimed in claim 12, there is provided a printer including in a piece an input unit for inputting content; a print unit for printing the input content on a medium; a display unit for displaying content with print specified on a screen; a control unit for causing the display unit to display the content being printed if a plurality of contents are printed continuously over a plurality of pages; and a cancel unit for canceling printing of the displayed content.

According to the printer according to claim 12, the user can monitor the content being printed without seeing the print result and can also enter a print cancel command. The printer, which is provided in one piece, can be handled easily.

The control unit of the printer according to claim 13 causes the display unit to display the content to be printed before printing the content is started.

According to the printer according to claim 13, content is displayed before print is started. Thus, before printing a specific page is started, the user can perform operation required for canceling printing the page.

### BRIEF DESCRIPTION OF THE DRAWINGS

In the accompanying drawings:

FIG. 1A to 1C are schematic drawings to describe the operation of a print system according to a first embodiment of the invention;

FIG. 2A is a perspective view to show the appearance of the print system according to the first embodiment of the invention, and FIG. 2B is a drawing to show a part of the print system on an enlarged scale;

FIG. 3 is a block diagram of the print system according to the first embodiment of the invention;

FIG. 4 is a data flow diagram of a print program according to the first embodiment of the invention;

FIG. 5 is a conceptual drawing of a print job of the print system according to the first embodiment of the invention;

FIGS. 6A and 6B are conceptual drawings to show the relationship between the image number and the serial number in the print system according to the first embodiment of the invention;

FIGS. 7A and 7B are conceptual drawings to show a print layout definition file in the print system according to the first embodiment of the invention;

FIG. 8 is a flowchart to show print control processing of the print system according to the first embodiment of the invention;

FIG. 9 is a flowchart to show processing of a display control process of the print program according to the first embodiment of the invention;

FIG. 10 is a schematic drawing to show the appearance of a print system according to a second embodiment of the invention;

FIG. 11 is a block diagram to show the print system according to the second embodiment of the invention;

FIG. 12 is a flowchart to show a processing flow of the print system according to the first embodiment of the invention; and

FIG. 13 is a schematic drawing to show the contents of removable memory connected to an input unit of the print system according to the first embodiment of the invention.

### DETAILED DESCRIPTION OF THE PREFERRED EMBODIMENTS

Referring now to the accompanying drawings, there are shown preferred embodiments of the invention.

### First Embodiment

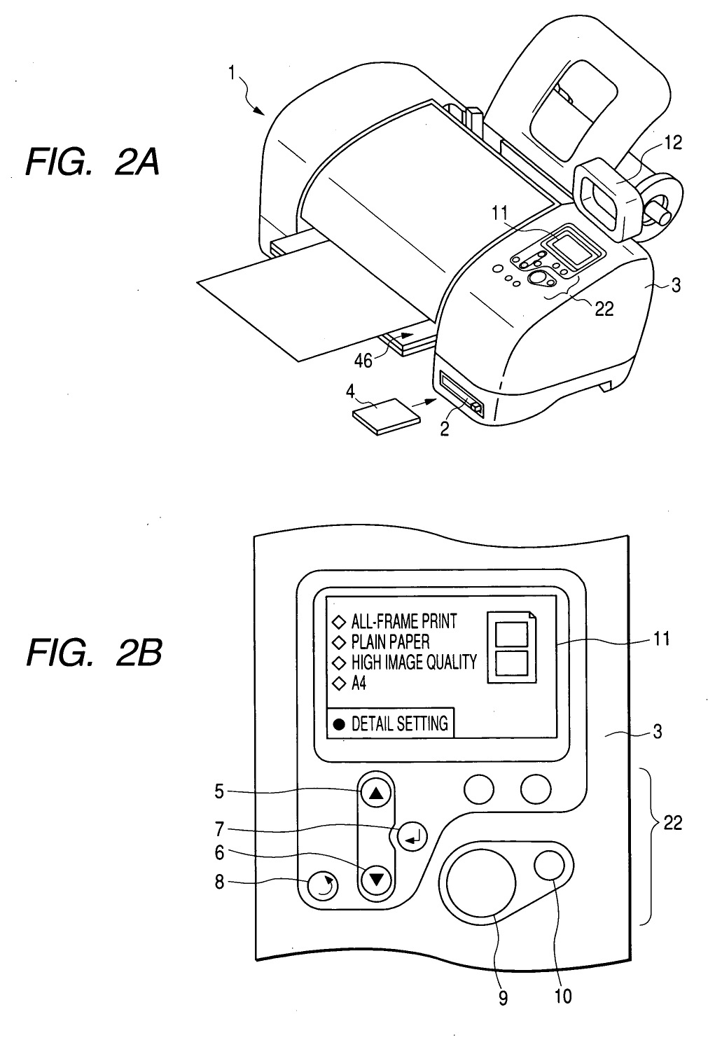

FIG. 2A is a perspective view to show the appearance of a print system 1 according to a first embodiment of the invention, and FIG. 2B is a drawing to show a first display 11 and an operation section 22 of the print system 1 on an enlarged scale.

A card slot 2 is an opening for connecting removal memory 4 detachably to a connector (not shown) provided in a housing 3.

An ejection port 46 is an opening for ejecting print paper after print.

As shown in FIG. 2B, the housing 3 is provided with an operation section 22 as an operation unit, and the operation section 22 is provided with a plurality of switches such as an upper switch 5, a lower switch 6, a determination switch 7, a return switch 8, a print start switch 9, and a cancel switch 10 as a cancel unit, and a first display 11 for displaying a menu for the user to set print conditions. The upper switch 5, the lower switch 6, the determination switch 7, and the return switch 8 are switches for the user to select menu items. The print start switch 9 is a switch for the user to enter a print start command. The cancel switch 10 is a switch for the user to enter a print cancel command.

As shown in FIG. 2A, the housing 3 is provided with a second display 12 as a display unit for displaying an image laid out for the current page being printed.

The housing 3 houses a power supply circuit, a control circuit, a drive circuit, an actuator, and the like making up a print unit.

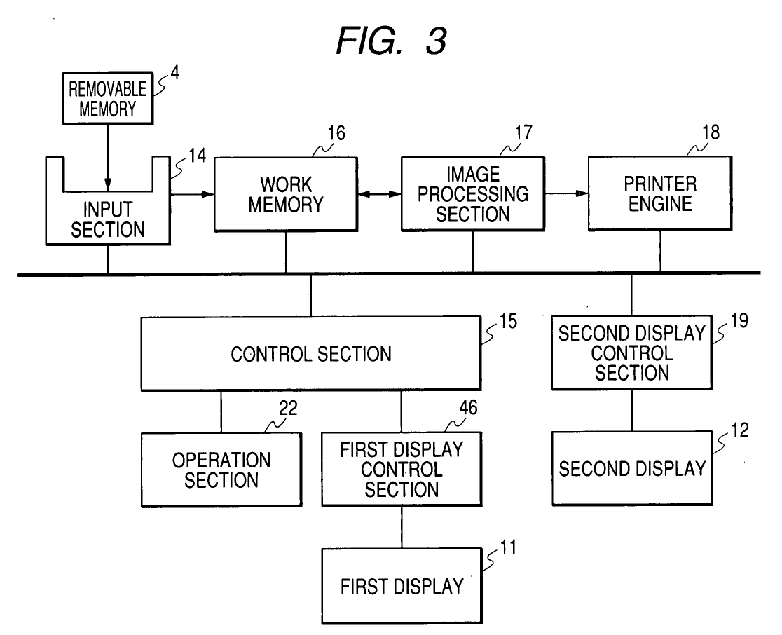

FIG. 3 is a block diagram of the print system 1 according to the first embodiment of the invention.

An input section 14 as an input unit reads data stored in the removal memory 4 and stores the data in work memory 16 under the control of a control section 15. The removal memory 4 is a record medium that can be attached to and detached from the input section 14; specifically it is card-type flash memory that can be attached to and detached from a digital camera, for example.

An image processing section 17 is an ASIC for executing processing for converting data stored in work memory 16 into print data in cooperation with the control section 15. Which of the processing section 15 and the image processing section 17 is to perform the processing for converting data into print data is a design item that can be selected appropriately. Specifically, for example, the image processing section 17 executes decompression processing, gamma correction, color space conversion processing, resolution conversion processing, halftone processing, interlace processing, etc., for the image data stored in the work memory 16.

A printer engine 18 forms an image on print paper as a medium based on print data provided by the image processing section 17 under the control of the control section 15. The printer engine 18 forms an image on print paper as a medium according to a system such as ink jet, laser, sublimatic thermal transfer, or dot impact, for example.

“Print unit” described in What Is Claimed Is corresponds to the image processing section 17, the printer engine 18, and the control section 15.

The second display 12 as a display unit displays image data as content stored in the removable under the control of a second display control section 19. The second display control section 19 includes VRAM, a drive circuit, etc. The second display control section 19 displays image data stored in the VRAM on the second display 12 under the control of the control section 15.

The control section 15 includes a CPU, RAM, and ROM as nonvolatile memory. The CPU executes a print program according to the first embodiment of the invention stored in the ROM and controls the sections of the print system 1. The ROM is memory previously storing documents and images as content, a print layout definition file, a display layout definition file, the print program, etc.

The print system 1 of the first embodiment includes the input section 14 as the input unit, the print unit, the second display 12 as the display unit, the control section 15 as the control unit, and the cancel switch 10 as the cancel unit in one piece in the housing 3. “Printer” described in What Is Claimed Is corresponds to the print system 1. That is, the print system 1 corresponds to both “print system” and “printer” described in What Is Claimed Is.

The input section 14 may be a wired interface of USB, etc., or a wireless interface of Bluetooth, etc., for connecting to an external system.

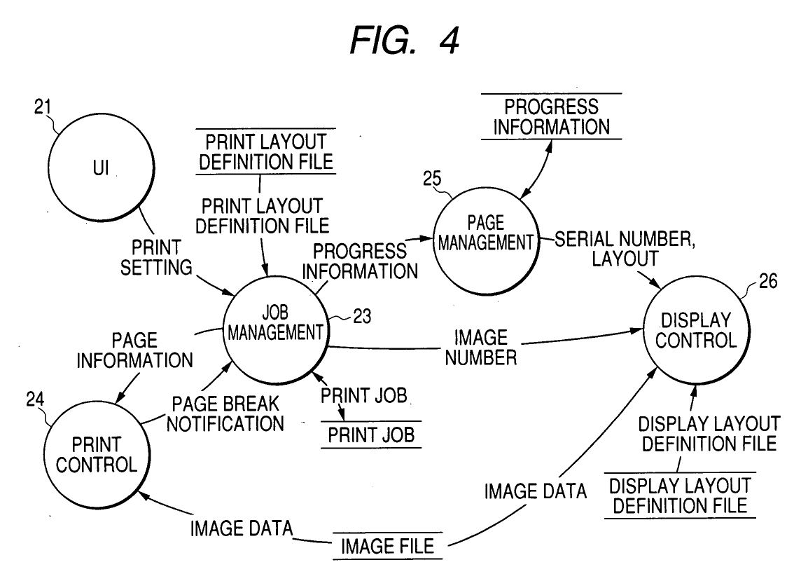

FIG. 4 is a data flow diagram of the print program according to the first embodiment of the invention.

A UI process 21 generates screen information displayed on the first display 11. As the user presses a switch on the operation section 22, the UI process 21 executes the following processing, for example, in response to the user operation: When the user selects a menu item by pressing the upper switch 5, the lower switch 6, the determination switch 7, the return switch 8, etc., the UI process 21 sets the print condition and the image number of the image to be printed based on the selected item. The print condition is information specifying the paper quality, the paper size, the print image quality, the number of print sheets, the layout defining the image arrangement and size, and the like. The image numbers are numbers provided in a one-to-one correspondence with image files stored in the removable memory 4 to uniquely identify the image files in the print system 1, and the image file specified by the setup image number becomes the image file whose print is specified. When the user presses the print start switch 9, the UI process 21 outputs the print setting containing the print condition and the image number to a job management process 23.

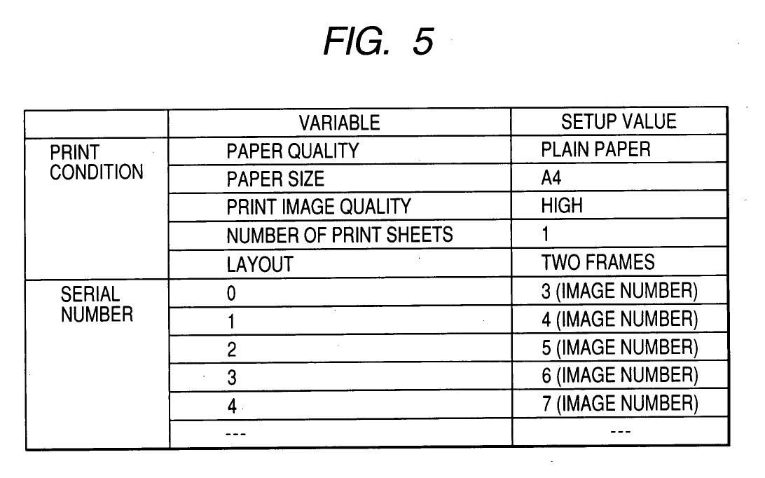

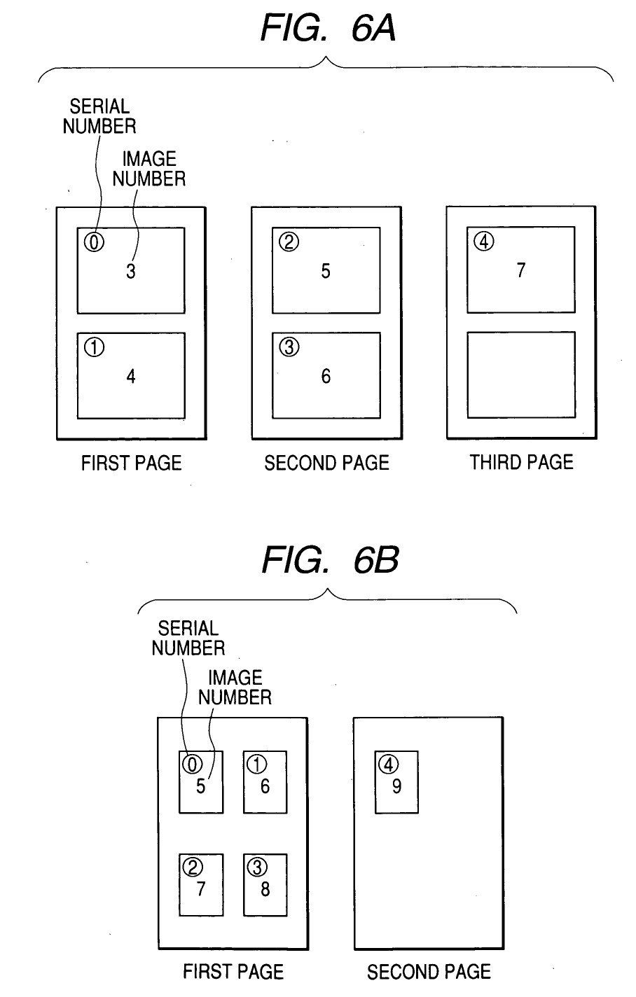

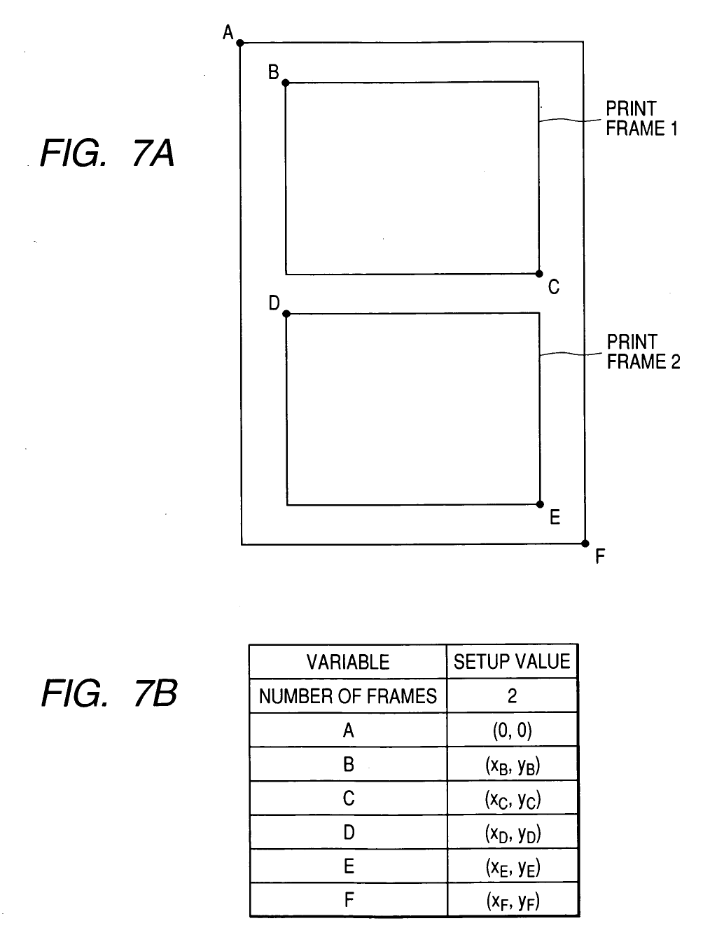

The job management process 23 generates a print job with the print condition, the image number, and the serial number associated with each other based on the print setting and the print layout definition file, and stores the print job in the work memory 16. One print job is generated each time the user presses the print start switch 9. FIG. 5 is a conceptual drawing of the print job. The serial numbers are serial numbers starting at 0, provided for each print job and are provided in a one-to-one correspondence with images to be printed. Each serial number corresponds to a variable for storing one image number. FIGS. 6A and 6B are conceptual drawings to show the relationship between the image number and the serial number. FIG. 6A shows a specific example wherein serial numbers 0 to 4 are assigned to the image numbers for a print job in which a two-frame layout is set for the image files with the image numbers 3 to 7. The n-frame layout refers to the layout for arranging n images on one page. FIG. 6B shows a specific example wherein serial numbers 0 to 4 are assigned to the image numbers for a print job in which a four-frame layout is set for the image files with the image numbers 5 to 9. The job management process 23 reads the print layout definition file stored in the ROM of the control section 15 into the work memory 16 based on the layout set as the print condition, analyzes the print layout definition file, and sets variables to generate page information, etc., described later. FIGS. 7A and 7B are conceptual drawings to show the print layout definition file corresponding to the two-frame layout. The print layout definition file is a file containing print layout definition information; specifically, for example, it is made up of variables storing the number of frames indicating the number of images (the number of print frames) laid out for the page defined in the file and the coordinates of the points shown in FIG. 7A, as shown in FIG. 7B.

Whenever a page break notification is input from a print control process 24, the job management process 23 outputs page information of the next page to the print control process 24. The page information is generated based on the image number, the print condition, and the print layout definition file; it is necessary information for creating one-page print data from image data. The job management process 23 always keeps track of the page number of the current page being printed based on the page break notification input from the print control process 24, etc. The image numbers of the next page are the image numbers assigned to the image file laid out for the next page and is specified based on the page number and the layout of the next page. Specifically, for example, in the print job shown in FIG. 5, the image numbers output to the print control process 24 for the second page of the two-frame layout are image number 5 stored in the variable with serial number 2 and image number 6 stored in the variable with serial number 3.

The job management process 23 outputs progress information containing the layout of the current page being printed and the smallest serial number assigned to the current page being printed according to the layout based on the page number of the current page being printed and the print job to a page management process 25 at predetermined time intervals (for example, 500-msec intervals). Specifically, for example, if the second page of the print job shown in FIG. 5 is being printed, the job management process 23 outputs the progress information containing “two-frame layout” as the layout and “2” as the serial number to the page management process 25.

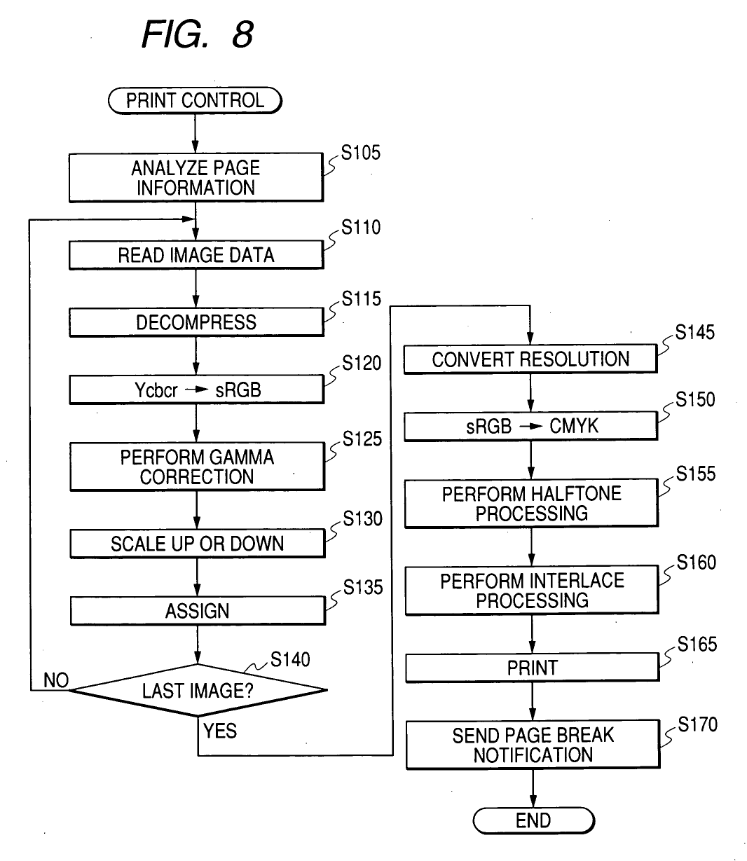

The print control process 24 prints an image file on print paper based on the page information input from the job management process 23 as follows: FIG. 8 is a flowchart to show the processing of the print control process 24.

At S105, the page information is analyzed and parameters required for converting image data to print data, such as the path of the image data laid out for the page, the image data layout position, the resolution, and the print size.

At S110, the image data laid out for the page is read into the work memory 16 from the removable memory 4. Specifically, for example, if high image quality with two-frame layout is selected as the print condition, the original image data of the Exif file specified by the image number is read; if low image quality with 20-frame layout is selected, the thumbnail image data of the Exif file specified by the image number is read.

At S115, for example, the image data compressed in JPEG for storage is decompressed in JPEG.

At S120, for example, the image data represented in YCbCr color space in JPEG is converted into sRGB color space of color space for performing image processing in the print system or the like.

At S125, gamma correction responsive to the characteristics of the print system is conducted.

At S130, the image data is scaled up or down, namely, pixels are interpolated or thinned out in response to the size of the print frame set in the print layout definition file.

At S135, the coordinates of the scaled-up or scaled-down image data are converted in response to the coordinates of the print frame defined in the print layout definition file, whereby the image data is laid out for the print frame.

At S140, whether or not any other image data to be laid out for the page exists is determined. If image data exists, the above-described processing is repeated; if not, the process proceeds to the next step.

At S145, the whole page is scaled up or down, namely, pixels are interpolated or thinned out in response to the print size and the print quality set as the print condition. This processing is not required if the print layout definition file exists for each print size, for each print quality.

At S150, for example, the image data is converted from the sRGB color space into CMYK color space in response to the color material of the print system.

At S155, halftone processing is executed, whereby gradation representation for each pixel is converted into gradation representation depending on the presence or absence of a large number of dots arranged in a matrix for generating binary print data. The halftone processing uses an error diffusion method or an ordered dither method.

At S160, interlace processing of sorting the print data in the output order to the printer engine 18 is executed.

At S165, ink droplets corresponding to the dots are fixed on print paper for forming an image on the print paper, for example, according to the ink jet system based on the print data.

At S170, a page break notification is output to the job management process 23 at the timing at which one-page print is complete. The description of the print control process 24 is now complete.

The page management process 25 temporarily stores the progress information input from the job management process 23 and outputs the serial number and the layout to a display control process 26 at predetermined time intervals (for example, 500-msec intervals) for the page being printed and the page just before print. The expression “just before print” is used to mean the time period until formation of the top line of the image printed on the following page is started after formation of the last line of the image printed on the preceding page ends. The progress information is overwritten whenever page break is executed, namely, a page break information is input from the print control process 24 to the job management process 23 and consequently new progress information is input to the page management process 25.

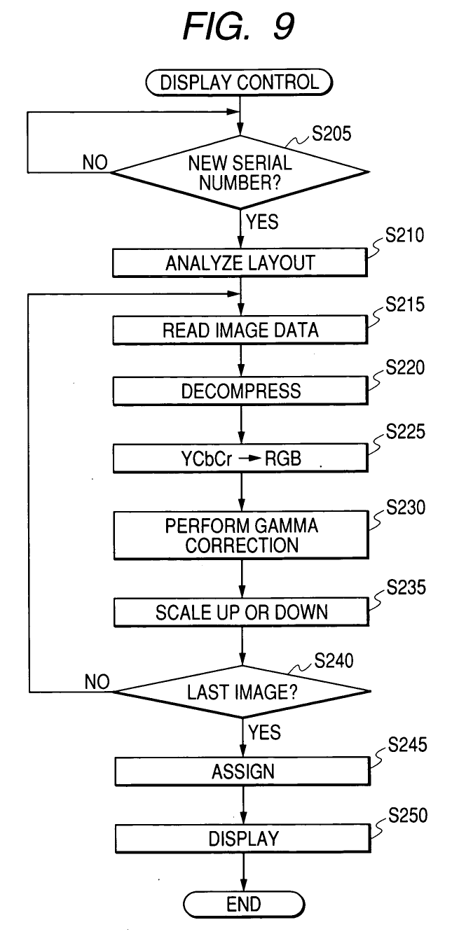

The display control process 26 displays the image files laid out for the page being printed and the page just before print based on the serial numbers, the layout, the image numbers, and the display layout definition file described later on the second display 12 as follows: FIG. 9 is a flowchart to show the processing of the display control process 26.

At S205, whether or not the serial number input from the page management process 25 is a new one different from the previously input serial number is determined. The display control process 26 waits until a new serial number is input. When a new serial number is input, the display control process 26 goes to the next step.

At S210, the display layout definition file stored in the ROM of the control section 15 is read into the work memory 16 based on the layout input from the page management process 25 and is analyzed, and various variables required for displaying image data are set. The display layout definition file is a file containing display layout definition information; specifically, for example, it is made up of variables storing the number of frames indicating the number of images laid out for the page defined in the file and the coordinates of the display frames. Conceptual drawings of the display layout definition file are substantially equal to those of FIGS. 7A and 7B and therefore are not shown. The layout defined in the display layout definition file is substantially similar to the layout defined in the print layout definition file.

At S215, the serial number and the display layout definition file input from the page management process 25 are analyzed and the image data to be laid out for the page is read from the removal memory 4 into the work memory 16. Specifically, for example, if “two-frame layout” and serial number “2” are input from the page management process 25, two-frame layout definition file is analyzed, whereby it is determined that the image files with the image numbers corresponding to the serial numbers “2” and “3” are laid out for the page, and the thumbnail image data stored in the image files with the image numbers corresponding to the serial numbers “2” and “3” is read into the work memory 16. To display an image comparatively largely on the second display 12 like one-frame layout, the original image data rather than the thumbnail image data may be displayed. Further, since it requires a comparatively long time to display the original image data, the thumbnail image data may be displayed prior to the original image data and when it becomes possible to display the original image data, the object displayed based on the thumbnail image data may be updated to the object to be displayed based on the original image data.

At S220, for example, the image data compressed in JPEG for storage is decompressed in JPEG.

At S225, for example, the image data represented in YCbCr color space in JPEG is converted into RGB color space of display.

At S230, gamma correction responsive to the characteristics of the second display 12 is conducted.

At S235, the image data is scaled up or down, namely, pixels are interpolated or thinned out in response to the size of the display frame set in the display layout definition file.

At S240, whether or not any other image data to be laid out for the page exists is determined. If image data exists, the above-described processing is repeated; if not, the process proceeds to the next step.

At S245, the scaled-up or scaled-down image data is stored in a predetermined area of the VRAM of the second display control section 19 in response to the coordinates of the display frame defined in the display layout definition file, whereby the image data is laid out for the display frame.

At S250, the image data laid out for the page being printed and the page just before print is displayed on the second display 12 based on the image data stored in the VRAM. At this time, the screen displayed on the second display 12 displays the print result of the whole of the page being printed and the page just before print with the print result scaled down almost as it is. To enable the user to enter a print cancel command with lead time before step S165 of the print control process 24 is started, it is desirable that the print result of the following page should be displayed on the second display 12 at early timing as much as possible before step S165 is started after print of the preceding page terminates.

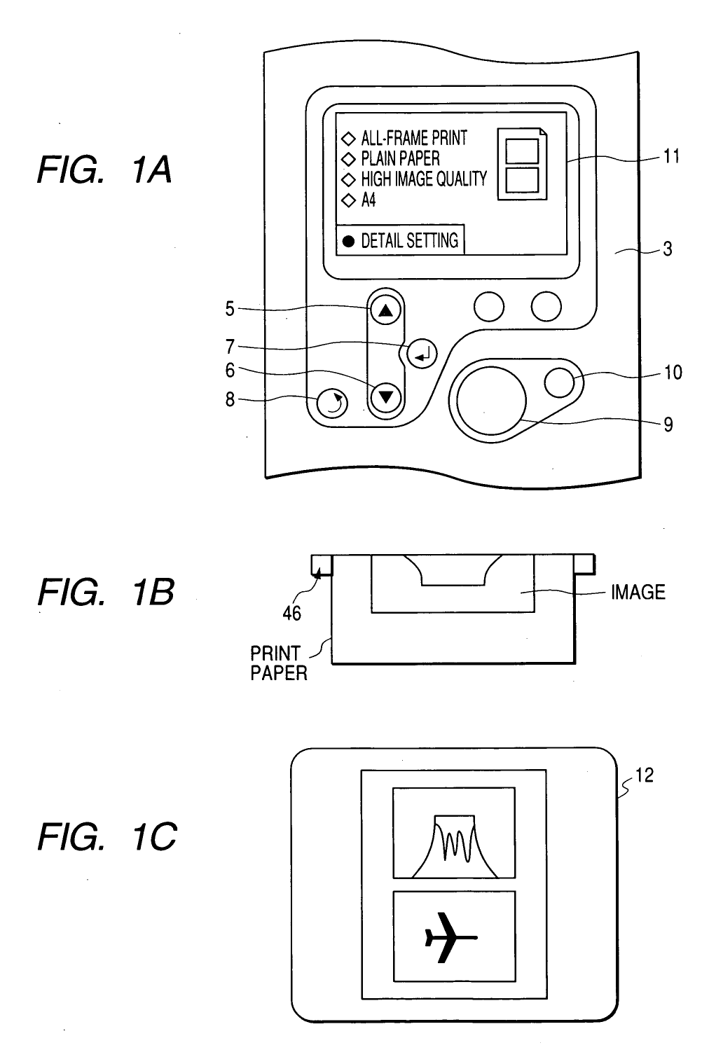

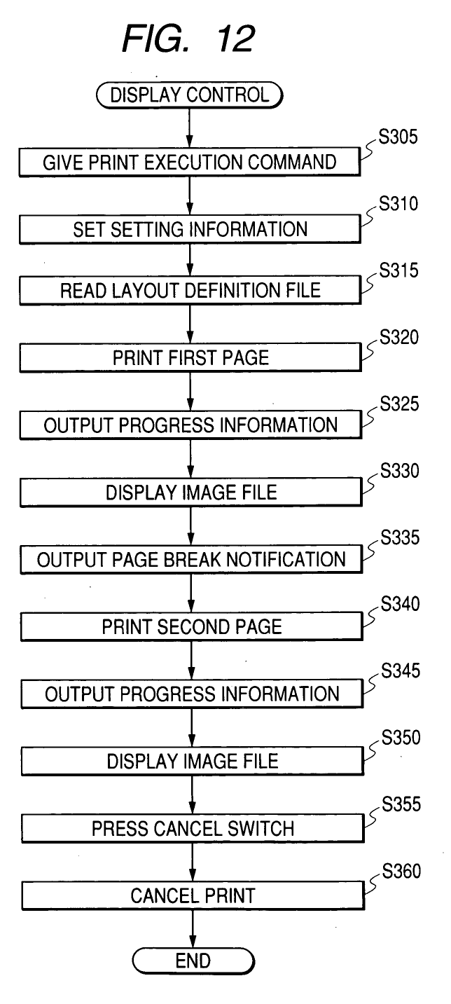

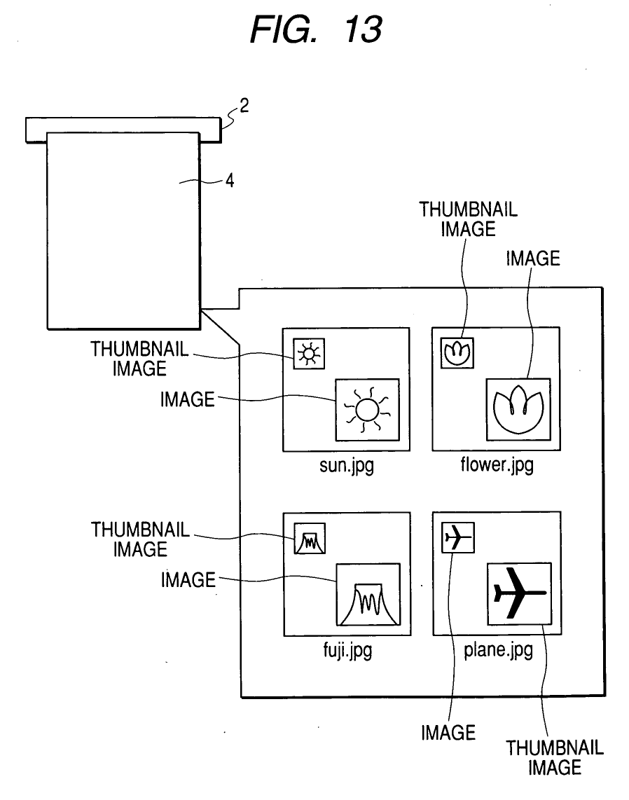

FIGS. 1 and 13 are schematic drawings to describe the operation of the print system according to the first embodiment of the invention. FIG. 12 is a flowchart to show a processing flow of the print system. The operation of the print system will be discussed by taking the case where print is canceled at a midpoint on the second page as an example.

At S305, the user inserts removable memory 4 recording one or more Exif files into the card slot 2 as shown in FIG. 13 and selects a menu item by operating the upper switch 5 and the lower switch 6 while seeing the menu displayed on the first display 11 by the UI process 21 as shown in FIG. 1A and then presses the print start switch 9.

At S310, upon detection of the print start switch 9 being pressed, the job management process 23 sets setting information containing the print condition and the image numbers from the user-selected menu items, etc.

At S315, the job management process 23 generates a print job from the setting information. Next, it reads the layout definition file based on the generated print job, analyzes the layout definition file, generates page information of the first page, and outputs the page information to the print control process 24. The job management process 23 also outputs progress information to the page management process 25 at predetermined time intervals.

At S320, the print control process 24 starts to print the first page as shown in FIG. 1B based on the page information of the first page.

At S325, the page management process 25 temporarily stores the first input progress information as new progress information and outputs to the display control process 26 the serial number “0” and the layout contained in the progress information temporarily stored until next new progress information is later input.

At S330, based on the serial number “0,” the layout, etc., the display control process 26 displays the image file laid out for the first page on the second display 12 as shown in FIG. 1C.

At S335, the print control process 24 outputs a page break notification to the job management process 23 at the timing at which printing the first page is complete. The job management process 23 outputs page information of the second page to the print control process 24 in response to input of the page break notification. The job management process 23 also outputs new progress information to the page management process 25 at predetermined time intervals.

At S340, the print control process 24 starts to print the second page based on the page information of the second page.

At S345, the page management process 25 temporarily stores the new progress information and outputs to the display control process 26 the serial number “2” and the layout contained in the progress information temporarily stored until next new progress information is later input.

At S350, based on the serial number “2,” the layout, etc., the display control process 26 displays the image file laid out for the second page on the second display 12.

At S355, the user checks the image file laid out for the second page displayed on the second display 12. If the user determines to cancel printing the second page and later as the check result, the user presses the cancel switch 10.

At S360, the processing of the processes is stopped. Accordingly, printing the second page being printed or just before print and printing the pages following the second page are canceled. Printing and canceling of the printing are thus performed.

In the embodiment, the example wherein a plurality of contents are laid out for one page for printing has been shown; however, the invention can also be applied to the case where one content is laid out for one page for printing.

To lay out a plurality of contents for one page, display may be switched every predetermined number of contents in response to the content print situation. Specifically, for example, the number of contents displayed in response to the print situation may be switched in response to the specified content layout position. That is, to print a page according to the layout as that of the first page in FIG. 6A, display may be changed every one content in response to the print situation (corresponding to switch of the image numbers 3 and 4); to print a page according to the layout as that of the first page in FIG. 6B, display may be changed every two contents in response to the print situation (corresponding to switch of the image numbers 5 and 6 and the image numbers 7 and 8). For example, in a serial printer, a record head is scanned two or more times in the main scanning direction for forming an image and thus display may be switched every number of contents placed in the main scanning direction.

### Second Embodiment

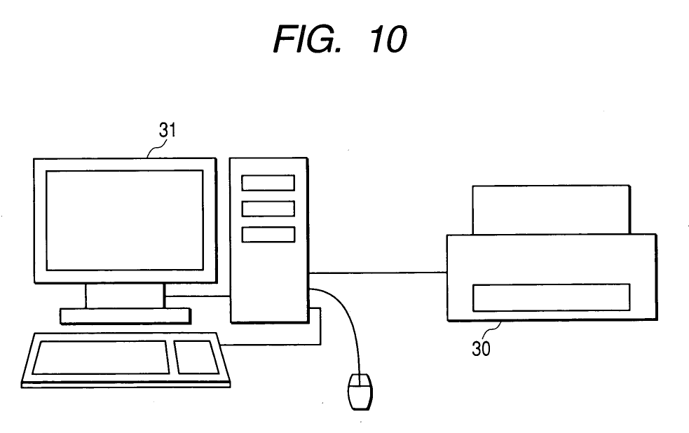

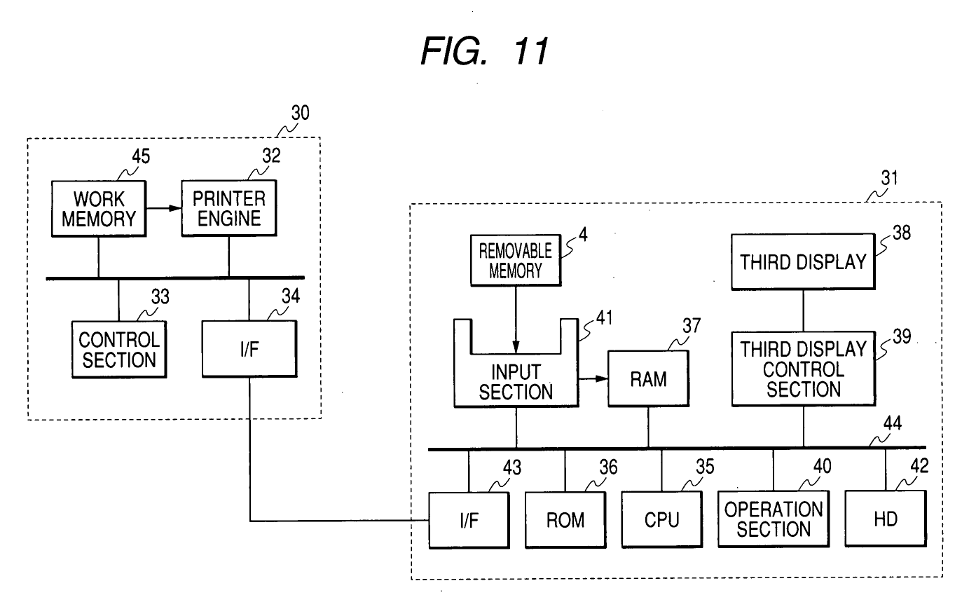

FIG. 10 is a schematic drawing to show the appearance of a print system according to a second embodiment of the invention. FIG. 11 is a block diagram to show the print system according to the second embodiment of the invention. The print system according to the second embodiment of the invention is made up of a printer 30 and a personal computer (PC) 31 for printing a document and an image stored in memory of the PC 31. Parts of the print system in the second embodiment substantially identical with those of the first embodiment will not be discussed again.

The printer 30 includes a printer engine 32, a control section 33, an interface 34, work memory 45, etc., and is connected to the PC 31 through the interface 34. The control section 33 includes a CPU and ROM, and the CPU executes program A (described later) stored in the ROM for controlling print.

The PC 31 includes a CPU 35, ROM 36, RAM 37, a third display 38 as a display unit, a third display controls section 39 for controlling the third display 38, an operation section 40 as an operation unit, an input section 41 as an input unit, a hard disk (HD) 42, an interface 43 for connecting the printer 30, etc., the components being connected by a bus 44.

The CPU 35 executes a control program stored in the ROM 36 and the operating system (OS) stored on the hard disk 42, thereby controlling the sections of the PC 31 and also executes print program B, etc., described later. The ROM 36 is memory previously storing the minimum control program and data required for the CPU 35 to operate. The RAM 36 is memory for temporarily storing various programs, data, etc., and is memory used as the work memory 16 in the first embodiment.

The operation section 40 as the operation unit includes a mouse, a keyboard, etc.

The input section 41 as the input unit reads data stored in removal memory 4 and stores the data in the RAM 37 under the control of the CPU 35. The removal memory 4 is a record medium that can be attached to and detached from the input section 41; specifically it is card-type flash memory that can be attached to and detached from a digital camera, for example. A storage unit using a removal medium such as a flexible disk, a magneto-optical disk (MO), or a compact disk (CD-ROM) may be used as the input section. The PC 31 may include a network interface as input unit for inputting content through the network interface.

The hard disk 42 includes a hard disk controller (not shown) and stores the OS, the print program B, a print layout definition file, a display layout definition file, etc.

The print program according to the second embodiment of the invention is made up of the print program A corresponding to a part of the print control process 24 in the first embodiment and the print program B corresponding to other parts of the print control process 24 and other processes than the print control process 24. The print program A is executed by the control section 33 of the printer 30. On the other hand, the print program B is installed as a printer driver and is executed by the CPU 35 of the PC 31.

Here, the expression “a part of the print control process 24” is specifically steps S165 and S170. The control section 33 outputs a page break notification through the interface 34 to the PC 31 at step S170. Steps S105 to S160 of the print control process 24 are executed by the PC 31, and the print data after execution of step S160 is output from the PC 31 through the interface 43 to the printer 30. Which steps of the print control process 24 in the first embodiment are to be executed by the PC 31 and which steps are to be executed by the printer 30 are design items that can be selected appropriately.

The processing to convert image data into print data executed by the image processing section 17 in the first embodiment is installed in the print program B in the second embodiment and is executed by the CPU 35. Which of the control section 33 and the CPU 35 is to perform the processing executed by the image processing section 17 is a design item that can be selected appropriately.

The function of “print unit” described in What Is Claimed Is corresponds to the function of the printer 30 and the function of the CPU 35 of the PC 31 for executing the print program B for converting image data into print data.

The third display 38 serves as both the first display 11 and the second display 12 in the first embodiment. The print program B displays both screen information of menu items, etc., and the image file laid out for a page.

The operation of the print system according to the second embodiment is substantially the same as that according to the first embodiment and therefore will not be discussed again.

According to the print systems according to the first and second embodiments described above, the content laid out for the page being printed is displayed on the second display 12 or the third display 38. Therefore, to continuously print a plurality of contents over a plurality of pages, the content being printed is displayed on the second display 12 or the third display 38. Thus, the print systems according to the first and second embodiments enable the user to monitor the content laid out for the page being printed without seeing the print result. Therefore, the user can easily determine whether or not the current page being printed is the page to cancel print, and can determine the timing to give a print cancel command while fully checking the print result of the page being printed. Accordingly, wasting of paper, ink, the print time, and the like can be avoided.

The print systems according to the first and second embodiments enable the user to watch what content is laid out for the current page being printed on the second display 12 or the third display 38, and can give the user a feeling of being safe that the printing proceeds normally.

In the second embodiment, the print system made up of the printer and the PC has been described, but the invention can also be applied to a system wherein an external machine such as a digital camera, a mobile telephone, a PDA, or a television receiver in place of the PC is connected to the printer. In this case, the display unit of the machine connected to the printer corresponds to the third display. However, the image being printed may be displayed on both or either of the display unit of the printer and the display unit of the machine connected to the printer. If the machine connected to the printer includes no display unit, the image being printed may be displayed on the display unit of the printer.

### Third Embodiment

A third embodiment of the invention provides an example of a display for displaying print content. In the description of the third embodiment, the case where a digital camera is used as a display of the invention is taken as an example. Parts in the third embodiment substantially identical with those in the first or second embodiment will not be discussed again.

A digital camera includes an image pickup section for photographing a subject and creating an image file, a display as a display unit for displaying content of an image file with print specified or the like on a screen, a control section as a control unit, an operation section including switches for the user to select items out of menus displayed on the display, a cancel switch for the user to enter a print cancel command, an input section for writing an image file into removable memory and reading an image file and a display layout definition file from removable memory, an interface, and the like, and is connected to a printer through the interface. The digital camera executes programs corresponding to the UI process 21 and the display control process 26 in the first embodiment.

The printer has substantially the same configuration as the print system 1 of the first embodiment except that it does not include the second display 12 and includes an interface. The printer executes programs corresponding to the job management process 23, the print control process 24, and the page management process 25 in the first embodiment.

In the third embodiment, a UI process 21 of the digital camera outputs not only print setting, but also the image file specified by the image number contained in the print setting to a job management process 23 of the printer. A page management process 25 of the printer transmits the serial number and the layout through the interface to the digital camera, and a display control process 26 of the digital camera displays the image file on the display based on the input serial number and layout. Consequently, to continuously print a plurality of contents over a plurality of pages, the content being printed is displayed on the display in response to the progress state and the content to be printed is displayed on the display before print is started.

If the user enters a print cancel command by pressing the cancel button during execution of print, the control section sends a print cancel command to the printer and stops the processing of the processes. Consequently, display switching of the image file to be printed is stopped. If display switching is stopped based on the print cancel command, switching of only display although print is canceled is avoided. Therefore, the user who monitors the content being printed does not get confused. The print cancel command may be input on the printer.

The described digital camera enables the user to monitor the content being printed without seeing the print result.

In the description of the third embodiment, the case where the digital camera is used as the display is taken as an example, but a mobile telephone including a display, a PDA, a television receiver including a control section, etc., may be used, for example, as the display of the invention.

The digital camera may display the whole or only a part of content. Specifically, for example, the whole of an image may be displayed as the image is scaled down, or only the area of a part of the image may be displayed without being scaled down.

1-13. (canceled)

14. A print system comprising:
an input unit that inputs content;
an operation unit that sets a print condition and enters a print execution command;
a print unit that prints input content on a medium based on the setup print condition when the print execution command is entered; and
a display unit that displays content laid out for the page being printed by the print unit.

15. The print system according to claim 14, wherein the display unit displays the whole of the page being printed by the print unit.

16. The print system according to claim 14, wherein the display unit displays the content laid out for the page to be printed by the print unit before print is started.

17. The print system according to claim 14 further comprising nonvolatile memory storing print layout definition information for laying out content for paper and display layout definition information for laying out content for a screen.

18. The print system according to claim 14 further comprising a housing provided with the input unit, the operation unit, the print unit, and the display unit,
wherein the input unit inputs data stored in a removable memory.

19. A print method comprising:
inputting content;
printing the input content on a medium; and
displaying content laid out for the page being printed.

20. A recording medium storing a program for causing a computer for controlling a print system that includes an input unit for inputting content, an operation unit that sets a print condition and enters a print execution command, a print unit that prints the input content on a medium based on the setup print condition when the print execution command is entered and a display unit, to cause the display unit to display content laid out for the page being printed by the print unit.

21. A display apparatus for displaying print content, comprising:
a display unit that displays content specified for printing on a screen; and
a control unit that causes the display unit to display the content being printed if a plurality of contents are printed continuously over a plurality of pages.

22. The display apparatus according to claim 21, wherein the control unit causes the display unit to display the content to be printed before printing the content is started.

23. The display apparatus according to claim 21, wherein the control unit stops display switching of the content to be printed based on a print cancel command.

24. The display apparatus according to claim 21, wherein the control unit causes the display unit to display at least a part of each content.

25. The display apparatus according to claim 21, wherein the control unit causes the display unit to change a display by a predetermined number of contents when a plurality of contents are laid out for one page.

26. A printer comprising:
an input unit that inputs content;
a print unit that prints the input content on a medium;
a display unit that displays content specified for print on a screen;
a control unit that causes the display unit to display the content being printed if a plurality of contents are printed continuously over a plurality of pages; and
a cancel unit that cancels printing of the displayed content.

27. The printer according to claim 26, wherein the control unit causes the display unit to display the content to be printed before printing the content is started.
